(19) United States
(12) Patent Application Publication
(10) Pub. No.: US 2026/0044013 A1
(43) Pub. Date: Feb. 12, 2026

(54) DISTANT-VIEW DISPLAY APPARATUS

(71) Applicant: HKC CORPORATION LIMITED, Shenzhen (CN)

(72) Inventors: Ye WAN, Shenzhen (CN); Lidan YE, Shenzhen (CN)

(73) Assignee: HKC CORPORATION LIMITED, Shenzhen (CN)

(21) Appl. No.: 19/284,582

(22) Filed: Jul. 29, 2025

(30) Foreign Application Priority Data
Aug. 7, 2024 (CN) 202411077519.X

(51) Int. Cl. G02B 27/09; G02B 27/02; G02B 27/28

(52) U.S. Cl. CPC G02B 27/0983; G02B 27/025; G02B 27/026; G02B 27/286

(57) ABSTRACT

A distant-view display apparatus includes: a housing formed with an accommodation chamber; a reflection assembly provided in the accommodation chamber; an image generation unit provided in the accommodation chamber; and a display panel provided between the reflection assembly and the image generation unit. A light-emitting direction of the image generation unit is towards the reflection assembly; a reflection polarizing layer is provided at one side of the display panel towards the reflection assembly; a first linearly polarized light emitted from the image generation unit is configured to pass through the display panel and the reflection polarizing layer in sequence and is transmitted to the reflection assembly; and the reflection assembly is configured to change a polarization direction of the first linearly polarized light to form a second linearly polarized light and reflect the second linearly polarized light to the reflection polarizing layer.

### CROSS-REFERENCE TO RELATED APPLICATIONS

The present application claims priority to Chinese Patent Application No. 202411077519.X, filed on Aug. 7, 2024, all of which are incorporated herein by reference in their entireties.

### TECHNICAL FIELD

The present application relates to the technical field of distant-view display apparatus, and in particular to a distant-view display apparatus.

### BACKGROUND

The distant-view display apparatus is a special optical device, which plays images through the image generation unit and reflects them to the curved imaging mirror through the display panel. The curved imaging mirror then reflects light to the display panel and passes through the display panel to the human eye, so that the human eye can see an enlarged and distant virtual image, achieving a distant viewing effect. However, when imaging in the existing distant-view display apparatus, the light emitted by the image generation unit needs to pass through the display panel twice, which results in low light utilization. The curved imaging mirror needs to be provided with a large longitudinal depth, which results in a large thickness of the distant-view display apparatus.

Therefore, it is necessary to provide a new distant-view display apparatus to solve the above technical problems.

### SUMMARY

The main purpose of the present application is to provide a distant-view display apparatus, aiming to solve the problems of low light utilization and large thickness of the existing distant-view display apparatus.

To achieve the above purpose, the present application provides a distant-view display apparatus, including:
a housing formed with an accommodation chamber;
a reflection assembly provided in the accommodation chamber;
an image generation unit provided in the accommodation chamber, wherein a light-emitting direction of the image generation unit is towards the reflection assembly; and
a display panel provided between the reflection assembly and the image generation unit; wherein
a reflection polarizing layer is provided at one side of the display panel towards the reflection assembly;
a first linearly polarized light emitted from the image generation unit is configured to pass through the display panel and the reflection polarizing layer in sequence and is transmitted to the reflection assembly; and
the reflection assembly is configured to change a polarization direction of the first linearly polarized light to form a second linearly polarized light and reflect the second linearly polarized light to the reflection polarizing layer, and the second linearly polarized light is reflected by the reflection polarizing layer and is emitted from the housing.

In an embodiment, the reflection assembly includes a reflector provided at a side of the display panel away from the image generation unit and a glass layer provided at a side of the reflector towards the display panel.

In an embodiment, a transparent substrate is provided at the side of the reflector towards the display panel, the transparent substrate is provided with an attachment plane, and the glass layer is attached to the attachment plane.

In an embodiment, the distant-view display apparatus further includes an adjust assembly configured to adjust a distance between the transparent substrate and the reflector, and a side of the transparent substrate away from the attachment plane is provided with a lens curved surface.

In an embodiment, the adjust assembly includes a drive member provided in the housing, a drive screw connected to the drive member, and a drive nut connected to the transparent substrate and sleeved at the drive screw.

In an embodiment, the distant-view display apparatus further includes a limit assembly, the limit assembly includes a limit slide rod provided in the housing and a limit slide sleeve connected to the transparent substrate and sleeved at the limit slide rod.

In an embodiment, the reflector includes a support area and a reflection area, the support area is formed with a mounting hole, the reflection area is provided in the mounting hole, and a control circuit layer is provided at one side of the support area away from the display panel.

In an embodiment, the reflection assembly is provided at a top of the accommodation chamber, and the image generation unit is provided at a bottom of the accommodation chamber.

In an embodiment, the reflection assembly is provided at a bottom of the accommodation chamber, and the image generation unit is provided at a top of the accommodation chamber.

In an embodiment, a notch is provided at the housing, a slide frame is slidably provided at the notch, the image generation unit is provided at the slide frame, and a charging interface is provided at the slide frame.

In an embodiment, the housing is provided with an opening communicated with the accommodation chamber, a viewing window panel is provided at the opening, and the second linearly polarized light reflected by the reflection polarizing layer is emitted from the housing through the viewing window panel.

The technical solution of the present application is to provide a reflection polarizing layer on the side of the display panel towards the reflection assembly, and provide a reflection assembly that can change the polarize direction of the linearly polarized light, so that the first linearly polarized light emitted by the image generation unit can be reflected out of the housing by the reflection polarizer after being reflected by the reflection assembly and changing the polarize direction. During imaging, the light emitted by the image generation unit only needs to pass through the display panel once, which can reduce the loss of light and improve the utilization rate of light. In addition, the reflection assembly and the image generation unit are relatively provided at both sides of the display panel, which can reduce the thickness of the distant-view display apparatus. Specifically, the reflection assembly is provided in an accommodation chamber of the housing, and the image generation unit is provided in the accommodation chamber with its light-emitting direction towards the reflection assembly. That is, the image generation unit and the reflection assembly are relatively provided in the accommodation chamber, so that the thickness of the distant-view display apparatus can be reduced, and the display panel is configured for viewing by the user. The reflection polarizing layer can allow the first linearly polarized light emitted by the image generation unit to transmit, and can reflect the second linearly polarized light formed after reflection by the reflection assembly to emit the second linearly polarized light out of the housing. The reflection assembly can change the polarization direction of the first linearly polarized light to form a second linearly polarized light, and can reflect the second linearly polarized light to the reflection polarizing layer. The first linearly polarized light emitted from the image generation unit is transmitted to the reflection assembly through the display panel and the reflection polarizing layer in sequence, the polarization direction of the first linearly polarized light is changed by the reflection assembly and the first linearly polarized light is emitted to the reflection polarizing layer as the second linearly polarized light, then the second linearly polarized light is reflected by the reflection polarizing layer and emitted out of the housing, and finally it is received by the human eye. The human eye can see a virtual image provided at the dashed box position B when observing the display panel at position A, thus achieving a distant view effect. The distant-view display apparatus can be applied to fields such as the automated teller machine (ATM), smart terminals and distant-view displays.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural diagram of a distant-view display apparatus in related art.

FIG. 2 is a schematic structural diagram of a distant-view display apparatus according to an embodiment of the present application where a reflection assembly is provided at a top of an accommodation chamber.

FIG. 3 is a schematic structural diagram of the distant-view display apparatus according to an embodiment of the present application where the reflection assembly is provided at a bottom of the accommodation chamber.

FIG. 4 is a schematic connection diagram of an adjust assembly, a limit assembly, a transparent substrate and a glass layer according to an embodiment of the present application.

FIG. 5 is a schematic structural diagram of a reflector according to an embodiment of the present application.

FIG. 6 is a schematic connection diagram of a housing, a slide frame and an image generation unit according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” or “or/and” appearing in the application includes three parallel scenarios. For example, “A and/or B” includes only A, or only B, or both A and B.

In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

In the related art, referring to FIG. 1, the distant-view display apparatus 100′ includes a housing 1′, an image generation unit 3′, a display panel 4′ and a reflector 21′. The display panel 4′ is installed at an opening 13′ of the housing 1′, the reflector 21′ is provided in the housing 1′ with its reflective concave surface towards the display panel 4′, and the image generation unit 3′ is provided at the bottom of the display panel 4′. The light emitted by the image generation unit 3′ is reflected by the display panel 4′ to the reflector 21′, and is reflected by the reflector 21′ and emitted from the light-emitting surface of the display panel 4′. A virtual image provided at a dashed box position B′ can be seen by the human eye when observing the display panel 4′ at position A′, thereby achieving a distant view effect. However, the light emitted by the image generation unit 3′ needs to pass through the display panel 4′ twice, which will reduce the utilization rate of the light. In addition, in order to ensure that the user can see a clear and complete virtual image, the reflector 21′ needs to be with a larger vertical depth, which will increase the thickness of the distant-view display apparatus 100′. It should be noted that the thickness of the distant-view display apparatus 100′ refers to the distance between the distant-view display apparatus 100′ and the virtual image in the direction of the human eye, that is, the distance in the X direction in FIG. 1.

The present application provides a distant-view display apparatus 100, which aims to solve the problems of low light utilization and large thickness of the distant-view display apparatus 100 in the related art.

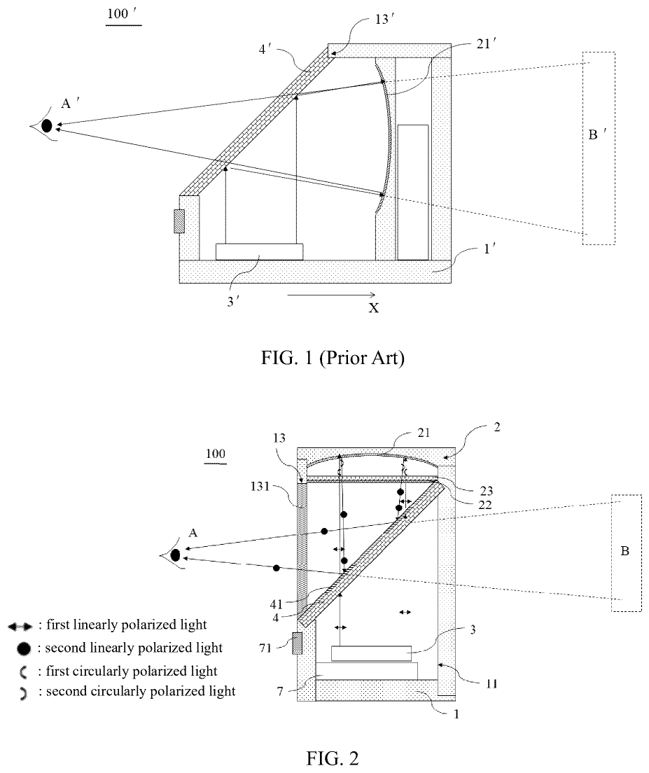

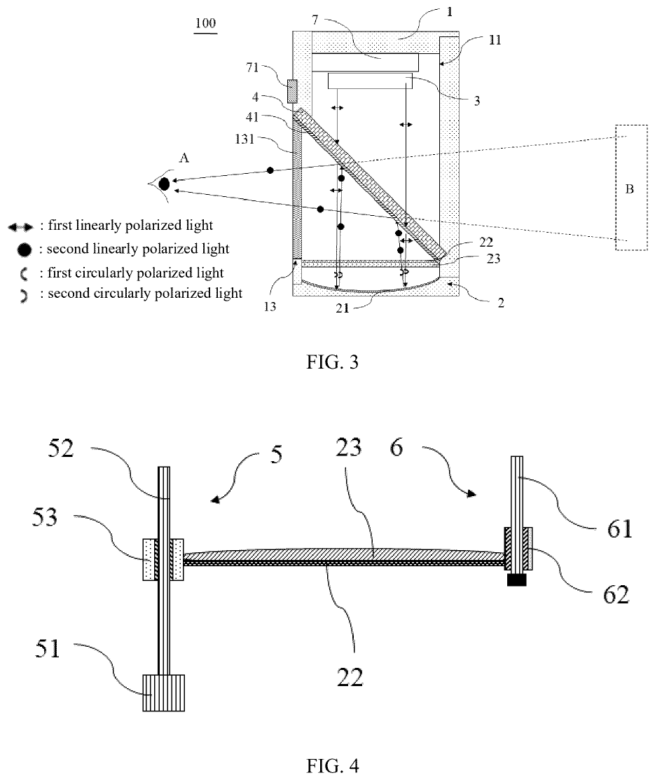

Referring to FIG. 2 and FIG. 3, in an embodiment of the present application, the distant-view display apparatus 100 includes a housing 1, a reflection assembly 2, an image generation unit 3, and a display panel 4. The housing 1 is formed with an accommodation chamber 11. Both the reflection assembly 2 and the image generation unit 3 are provided in the accommodation chamber 11, and the light-emitting direction of the image generation unit 3 is towards the reflection assembly 2. The display panel 4 is provided between the reflection assembly 2 and the image generation unit 3. A reflection polarizing layer 41 is provided at the side of the display panel 4 towards the reflection assembly 2. The first linearly polarized light emitted from the image generation unit 3 sequentially passes through the display panel 4 and the reflection polarizing layer 41 and is transmitted to the reflection assembly 2. The reflection assembly 2 can change the polarization direction of the first linearly polarized light to form a second linearly polarized light, and reflect the second linearly polarized light to the reflection polarizing layer 41. The second linearly polarized light is reflected by the reflection polarizing layer 41 and is emitted from the housing 1.

The technical solution of the present application is to provide a reflection polarizing layer 41 on the side of the display panel 4 towards the reflection assembly 2, and provide a reflection assembly 2 that can change the polarize direction of the linearly polarized light, so that the first linearly polarized light emitted by the image generation unit 3 can be reflected by the reflection polarizer out of the housing 1 after being reflected by the reflection assembly 2 and changing the polarize direction. During imaging, the light emitted by the image generation unit 3 only needs to pass through the display panel 4 once, which can reduce the loss of light and improve the utilization rate of light. In addition, the reflection assembly 2 and the image generation unit 3 are relatively provided at both sides of the display panel 4, which can reduce the thickness of the distant-view display apparatus 100. Specifically, the reflection assembly 2 is provided in the accommodation chamber 11 of the housing 1, and the image generation unit 3 is provided in the accommodation chamber 11 with its light-emitting direction towards the reflection assembly 2. That is, the image generation unit 3 and the reflection assembly 2 are relatively provided in the accommodation chamber 11, which can reduce the thickness of the distant-view display apparatus 100, and the display panel 4 is configured for viewing by the user. The reflection polarizing layer 41 can allow the first linearly polarized light emitted by the image generation unit 3 to transmit, and can reflect the second linearly polarized light formed after reflection by the reflection assembly 2 to emit the second linearly polarized light out of the housing 1. The reflection assembly 2 can change the polarization direction of the first linearly polarized light to form a second linearly polarized light, and can reflect the second linearly polarized light to the reflection polarizing layer 41. The first linearly polarized light emitted from the image generation unit 3 is transmitted to the reflection assembly 2 through the display panel 4 and the reflection polarizing layer 41 in sequence, the polarization direction of the first linearly polarized light is changed by the reflection assembly 2 and the first linearly polarized light is emitted to the reflection polarizing layer 41 as the second linearly polarized light, then the second linearly polarized light is reflected by the reflection polarizing layer 41 and emitted out of the housing 1, and finally it is received by the human eye. Referring to FIG. 2 and FIG. 3, the virtual image provided at the dashed box position B can be seen by the human eye when observing the display panel 4 at position A, thus achieving the distant view effect. The distant-view display apparatus 100 can be applied to fields such as the automated teller machine (ATM), smart terminals and distant-view displays.

It should be noted that in the embodiment of the present application, the display panel 4 can transmit the light emitted by the image generation unit 3. In an embodiment, the display panel 4 can be a semi-transparent and semi-reflective plate. The image generation unit 3 is configured to generate an image, and the image information is emitted in the form of light. There are two ways to make the image generation unit 3 emit the first linearly polarized light, one of which is to use a display screen that can directly emit the linearly polarized light, and the other is to use a display screen that can emit the ordinary light and attach a polarizing film to the display screen. The reflection polarizing layer 41 provided at the side of the display panel 4 towards the reflection assembly 2 can be achieved by attaching a reflection polarizer on the side of the display panel 4 towards the reflection assembly 2. The reflection polarizing layer 41 can transmit the first linearly polarized light emitted by the image generation unit 3 with a transmittance higher than 90%, and can reflect the second linearly polarized light formed after reflection by the reflection assembly 2 with a reflectivity higher than 90%.

In an embodiment, the first linearly polarized light emitted by the image generation unit 3 is the P polarized light, and the second linearly polarized light formed after being reflected by the reflection assembly 2 is the S polarized light. The reflection polarizer is in the spectral range of 450 nm-650 nm, which has a transmittance of greater than 95% for the P polarized light and a reflectance of less than 0.2% for the P polarized light, and has a reflectance of greater than 95% for the S polarized light and a transmittance of less than 0.01% for the S polarized light.

Referring to FIG. 2 and FIG. 3, in an embodiment of the present application, the reflection assembly 2 includes a reflector 21 and a glass layer 22. The reflector 21 is provided at a side of the display panel 4 away from the image generation unit 3, and the glass layer 22 is provided at a side of the reflector 21 towards the display panel 4. The reflector 21 is configured to reflect the circularly polarized light and change the polarization direction of the circularly polarized light. The glass layer 22 is configured to realize the conversion between the circularly polarized light and the linearly polarized light. In an embodiment, the glass layer 22 is a ¼λ glass sheet. When the distant-view display apparatus 100 is imaging, the first linearly polarized light emitted by the image generation unit 3 passes through the display panel 4 and the reflection polarizing layer 41 in sequence, and passes through the glass layer 22 and is converted into the first circularly polarized light (left-handed circularly polarized light) under the action of the glass layer 22. Then, the first circularly polarized light is reflected by the reflector 21, simultaneously undergoes a 7L phase transition, and is converted into the second circularly polarized light (right-handed circularly polarized light). Then, the first circularly polarized light passes through the glass layer 22 again, and is converted into the second linearly polarized light under the action of the glass layer 22. Then, the second linearly polarized light is reflected by the reflection polarizing layer 41 and emitted out of the housing 1, and is finally received by the human eyes.

Referring to FIG. 2 to FIG. 4, in an embodiment of the present application, a transparent substrate 23 is provided at the side of the reflector 21 towards the display panel 4. The transparent substrate 23 is provided with an attachment plane, and the glass layer 22 is attached to the attachment plane. Attaching the glass layer 22 to the attachment plane of the transparent substrate 23 can reduce the difficulty of attaching the glass layer 22, thereby reducing the difficulty of assembling the distant-view display apparatus 100. It should be noted that the glass layer 22 is usually a parallel plane plate made of birefringent material cut in a direction parallel to the optical axis, and the difficulty of attaching the glass layer 22 to a curved surface and a flat surface is different. The difficulty of attaching the pick layer to the flat surface is lower than the difficulty of attaching the glass layer 22 to the curved surface. In an embodiment, the transparent substrate 23 is an optical glass with a light transmittance greater than 99%.

Referring to FIG. 4, in an embodiment of the present application, a side of the transparent substrate 23 away from the attachment plane is provided with a lens curved surface. The distant-view display apparatus 100 further includes an adjust assembly 5 configured to adjust the distance between the transparent substrate 23 and the reflector 21. The lens curved surface can change the optical path, improve the refractive power, thereby shortening the distance between the virtual image and the display panel 4, and reducing the thickness of the distant-view display apparatus 100. The adjust assembly 5 can adjust the distance between the transparent substrate 23 and the reflector 21, thereby adjusting the size of the second linearly polarized light transformed by the glass layer 22 irradiated on the reflection polarizing layer 41, and adjusting the position of the virtual image. In an embodiment, the adjustment range of the position of the virtual image is 0.8 m to 10 m. At the same time, the lens curved surface can be provided at the side of the high-transmittance substrate towards the reflector 21, or on the side of the high-transmittance substrate away from the reflector 21. When the lens curved surface is provided at the side of the high-transmittance substrate towards the reflector 21, the attachment plane is provided at the side of the high-transmittance substrate away from the reflector 21; when the lens curved surface is provided at the side of the high-transmittance substrate away from the reflector 21, the attachment plane is provided at the side of the high-transmittance substrate towards the reflector 21.

Referring to FIG. 4, in an embodiment of the present application, the adjust assembly 5 includes a drive member 51, a drive screw 52 and a drive nut 53. The drive member 51 is provided at the housing 1, the drive screw 52 is connected to the drive member 51, and the drive nut 53 is connected to the transparent substrate 23 and is sleeved at the drive screw 52. The drive member 51 can drive the drive screw 52 to rotate, and drive the drive nut 53 to move along the axis direction of the drive screw 52, so as to adjust the distance between the transparent substrate 23 and the reflector 21. The distance between the transparent substrate 23 and the reflector 21 can be adjusted by the cooperation of the drive screw 52 and the drive nut 53, which has the simple structure and convenient manufacturing, and can reduce the manufacturing difficulty of the distant-view display apparatus 100. In an embodiment, the drive member 51 is a driving motor.

Referring to FIG. 4, in an embodiment of the present application, the distant-view display apparatus 100 also includes a limit assembly 6. The limit assembly 6 includes a limit slide rod 61 and a limit slide sleeve 62. The limit slide rod 61 is provided at the housing 1, and the limit slide sleeve 62 is connected to the transparent substrate 23 and sleeved at the limit slide rod 61. The limit slide rod 61 can limit the position of the limit slide sleeve 62, and further limit the position of the transparent substrate 23, so that the position of the virtual image can be adjusted within a preset range. In an embodiment, the limit slide rod 61 can adjust the position of the virtual image within the range of 0.8 m to 10 m.

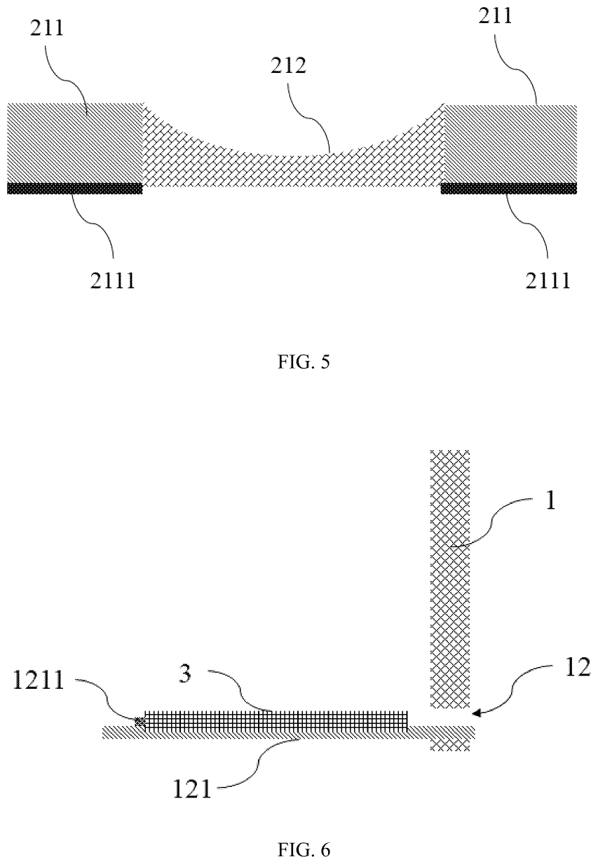

Referring to FIG. 5, in an embodiment of the present application, the reflector 21 includes a support area 211 and a reflection area 212. The support area 211 is formed with a mounting hole. The reflection area 212 is provided in the mounting hole. A control circuit layer 2111 is provided at a side of the support area 211 away from the display panel 4. The reflection area 212 is a curved reflection area. Specifically, the reflection area 212 is made of glass, and a reflective coating for reflecting light is coated on the reflection area 212. The control circuit layer 2111 is provided in a layered form on a side of the support area 211 away from the display panel 4, replacing the control assembly 7 in the related art. That is, by providing the control circuit layer 2111 in the support area 211, the control assembly 7 can be eliminated, which not only reduces the production cost, but also eliminates the need to assemble the control assembly 7, improves the assembly efficiency, and reduces the overall size of the distant-view display apparatus 100, so that the distant-view display apparatus 100 can be installed in some small-sized spaces, such as the headrest area of a car. The integrated design of the reflector 21 and the control circuit layer 2111 can reduce the vibration of the control circuit layer 2111 during the driving, so as to solve the problem that the control assembly 7 (printed circuit board, PCB) in the related art is loosely installed due to the separate arrangement. In addition, the control circuit layer 2111 is provided at the side of the support area 211 away from the display panel 4, that is, the control circuit layer 2111 is provided at the side of the support area 211 away from the image generation unit 3, and the reflector 21 can be as a heat insulating member to separate the control circuit layer 2111 from the environment where the image generation unit 3 is provided, so as to prevent the heat generated by the image generation unit 3 from affecting the stability of the control circuit layer 2111. It should be noted that when the control circuit layer 2111 is provided at the support area 211, the control circuit layer 2111 needs to avoid the reflection area 212, so as to prevent the manufacturing of the driving circuit from damaging the thinner position of the curved reflection area 212. In an embodiment, the manufacturing process of the control circuit layer 2111 is similar to the manufacturing of the thin film transistor (TFT). For example, a conductive film can be deposited on the surface of the reflection area 212, a photoresist can be coated on the conductive film, and a suitable mask can be selected for exposure according to the pattern or shape of the control circuit layer 2111 to be obtained. After the exposure, etching can be performed, which can be dry etching or wet etching. Finally, the remaining photoresist can be removed by heating and curing, and the desired control circuit layer 2111 can be obtained. In addition, in an embodiment, a protective film can be deposited on the reflection area 212, which can be physical vapor deposition or chemical vapor deposition.

In an embodiment of the present application, a control assembly 7 is provided in the accommodation chamber 11, and a button 71 is provided at the housing 1. Both the image generation unit 3 and the button 71 are connected to the control assembly 7 through electrical signals. The control assembly 7 is configured to control the screen displayed by the image generation unit 3, and the button 71 is configured to realize human-computer interaction. Specifically, both the button 71 and the image generation unit 3 are connected to the control assembly 7 through a flat cable. It should be noted that if the distant-view display apparatus 100 has adopted the structure of the control circuit layer 2111, it is not necessary to provide the control assembly 7 in the accommodation chamber 11, which can reduce the production cost and improve the assembly efficiency.

Referring to FIG. 2 and FIG. 3, in an embodiment of the present application, the reflection assembly 2 is provided at the top of the accommodation chamber 11, and the image generation unit 3 is provided at the bottom of the accommodation chamber 11; or the reflection assembly 2 is provided at the bottom of the accommodation chamber 11, and the image generation unit 3 is provided at the top of the accommodation chamber 11. Specifically, the reflection assembly 2 and the image generation unit 3 are respectively provided at the bottom and the top of the accommodation chamber 11, and it only needs to make the reflection assembly 2 and the image generation unit 3 relatively provided at both sides of the display panel 4. It should be noted that when the reflector 21 in the reflection assembly 2 is made of metal material, ceramic material, etc., the weight of the reflection assembly 2 itself is relatively heavy. In order to ensure the stability of the distant-view display apparatus 100, the reflection assembly 2 needs to be installed at the bottom of the accommodation chamber 11. When the reflector 21 in the reflection assembly 2 is made of glass material, etc., the weight of the reflection assembly 2 itself is relatively light, and the reflection assembly 2 can be installed at the top of the accommodation chamber 11.

Referring to FIG. 6, in an embodiment of the present application, a notch 12 is provided at the housing 1, a slide frame 121 is slidably provided at the notch 12, the image generation unit 3 is provided at the slide frame 121, and a charging interface 1211 is provided at the slide frame 121. The slide frame 121 is slidably provided at the notch 12, so that the slide frame 121 can slide on the notch 12 and pull out the display screen on the slide frame 121 together. That is, the image generation unit 3 can be pulled out from the housing 1 and used as a display panel alone, and it is also convenient for the repair and replacement of the image generation unit 3. In an embodiment, the slide frame 121 is formed with a clamping slot for at least partially accommodating the image generation unit 3. The slide frame 121 is provided with a charging interface 1211. When the image generation unit 3 is put back into the slide frame 121, the image generation unit 3 can be charged by being electrically connected to the image generation unit 3 through the charging interface 1211. Specifically, the charging interface 1211 can be electrically connected to the image generation unit 3 through a power cord, or can be directly connected in the form of a gold finger.

Referring to FIG. 2 and FIG. 3, in an embodiment of the present application, the housing 1 is provided with an opening 13 communicated with the accommodation chamber 11, and a viewing window panel 131 is provided at the opening 13. The second linearly polarized light reflected by the reflection polarizing layer 41 is emitted from the housing 1 through the viewing window panel 131. The opening 13 allows the second linearly polarized light reflected by the reflection polarizing layer 41 to pass through, and the second linearly polarized light can pass through the opening 13 and be emitted from the housing 1 to be received by human eyes. The viewing window panel 131 can separate the accommodation chamber 11 of the housing 1 from the external environment, thereby preventing the reflection polarizing layer 41 from being exposed, so as to avoid damage and dust on the reflection polarizing layer 41. In an embodiment, the viewing window panel 131 is an optical glass with a light transmittance greater than 99%.

The optical path of the distant-view display apparatus 100 is as follows: the first linearly polarized light emitted by the image generation unit 3 passes through the display panel 4 and the reflection polarizing layer 41 in sequence, and passes through the glass layer 22 and is transformed into the first circularly polarized light under the action of the glass layer 22. The first circularly polarized light passes through the transparent substrate 23 and is reflected by the reflector 21, and simultaneously undergoes a 7L phase transition and is transformed into the second circularly polarized light. The second circularly polarized light passes through the transparent substrate 23 and the glass layer 22 in sequence, and is transformed into the second linearly polarized light under the action of the glass layer 22. Finally, the second linearly polarized light is reflected by the reflection polarizing layer 41, passes through the viewing window panel 131 and is emitted from the housing 1, and is finally received by the human eye. Referring to FIG. 2 and FIG. 3, when observing the display panel 4 at position A, the human eye can see a virtual image provided at the dashed box position B, thereby achieving the distant view effect.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A distant-view display apparatus, comprising:
a housing formed with an accommodation chamber;
a reflection assembly provided in the accommodation chamber;
an image generation unit provided in the accommodation chamber, wherein a light-emitting direction of the image generation unit is towards the reflection assembly; and
a display panel provided between the reflection assembly and the image generation unit; wherein
a reflection polarizing layer is provided at one side of the display panel towards the reflection assembly;
a first linearly polarized light emitted from the image generation unit is configured to pass through the display panel and the reflection polarizing layer in sequence and is transmitted to the reflection assembly; and
the reflection assembly is configured to change a polarization direction of the first linearly polarized light to form a second linearly polarized light and reflect the second linearly polarized light to the reflection polarizing layer, and the second linearly polarized light is reflected by the reflection polarizing layer and is emitted from the housing.

2. The distant-view display apparatus according to claim 1, wherein the reflection assembly comprises a reflector provided at a side of the display panel away from the image generation unit and a glass layer provided at a side of the reflector towards the display panel.

3. The distant-view display apparatus according to claim 2, wherein a transparent substrate is provided at the side of the reflector towards the display panel, the transparent substrate is provided with an attachment plane, and the glass layer is attached to the attachment plane.

4. The distant-view display apparatus according to claim 3, further comprising an adjust assembly configured to adjust a distance between the transparent substrate and the reflector, wherein a side of the transparent substrate away from the attachment plane is provided with a lens curved surface.

5. The distant-view display apparatus according to claim 4, wherein the adjust assembly comprises a drive member provided in the housing, a drive screw connected to the drive member, and a drive nut connected to the transparent substrate and sleeved at the drive screw.

6. The distant-view display apparatus according to claim 4, further comprising a limit assembly, wherein the limit assembly comprises a limit slide rod provided in the housing and a limit slide sleeve connected to the transparent substrate and sleeved at the limit slide rod.

7. The distant-view display apparatus according to claim 2, wherein the reflector comprises a support area and a reflection area, the support area is formed with a mounting hole, the reflection area is provided in the mounting hole, and a control circuit layer is provided at one side of the support area away from the display panel.

8. The distant-view display apparatus according to claim 1, wherein the reflection assembly is provided at a top of the accommodation chamber, and the image generation unit is provided at a bottom of the accommodation chamber.

9. The distant-view display apparatus according to claim 1, wherein the reflection assembly is provided at a bottom of the accommodation chamber, and the image generation unit is provided at a top of the accommodation chamber.

10. The distant-view display apparatus according to claim 1, wherein a notch is provided at the housing, a slide frame is slidably provided at the notch, the image generation unit is provided at the slide frame, and a charging interface is provided at the slide frame.

11. The distant-view display apparatus according to claim 1, wherein the housing is provided with an opening communicated with the accommodation chamber, a viewing window panel is provided at the opening, and the second linearly polarized light reflected by the reflection polarizing layer is emitted from the housing through the viewing window panel.
